(19) United States
(12) Patent Application Publication
(10) Pub. No.: US 2014/0358590 A1
(43) Pub. Date: Dec. 4, 2014

(54) TRACKING EROSION OF AGGREGATE LIMITS

(71) Applicant: Bank of America Corporation, Charlotte, NC (US)

(72) Inventor: Adriaan SCHIEFERDECKER, Harrisburg, NC (US)

(21) Appl. No.: 13/906,790

(22) Filed: May 31, 2013

(51) Int. Cl. G06Q 40/08

(52) U.S. Cl. CPC G06Q 40/08
USPC 705/4

(57) ABSTRACT

Systems, methods and apparatuses for tracking erosion of insurance funds available in an aggregate environment are provided. In some examples, insurance policy information may be received and aggregated by coverage type into subject-oriented insurance segments. Within the subject-oriented insurance segments the various policies for that coverage type may be represented as policy segments. When a claim is made, the claim may be paid out of a policy segment that spans multiple coverage types and thus multiple subject-oriented insurance segments. The system may track these claims and reduce the amount of insurance available for each subject-oriented insurance segment associated with the policy segment from which the claim is being made.

### BACKGROUND

Accuracy and efficiency are important in many aspects of business. For instance, companies or other entities having multiple insurance policies must have a clear understanding of the limits of the policies, the amount of insurance remaining available on the policies, and the like. Some conventional systems do not accurately represent an amount of insurance available because insurance spanning multiple coverage types may not reflect claims paid out from the policy for each coverage type. Rather, only the coverage type associated with the claim will be reduced by the amount of the claim. This leaves an inaccurate indication of the amount of insurance available for the other coverage types associated with that policy. Accordingly, accurately tracking the erosion of insurance policies and available funds may improve efficiency and accuracy in processing claims and forecasting for future expenses.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure relate to methods, computer-readable media, systems and apparatuses for tracking erosion of insurance funds available in an aggregate environment. The methods, computer-readable media, systems and apparatuses may receive policy information and aggregate the policy information by coverage type into subject-oriented insurance segments. Within the subject-oriented insurance segments the various policies for that coverage type may be represented as policy segments. When a claim is made, the claim may be paid out of a policy segment that spans multiple coverage types and thus multiple subject-oriented insurance segments. Accordingly, the methods, systems, apparatuses and computer-readable media described herein may track these claims and reduce the amount of insurance available for each subject-oriented insurance segment associated with the policy segment from which the claim is being made.

### BRIEF DESCRIPTION OF THE DRAWINGS

The present disclosure is illustrated by way of example and not limited in the accompanying figures in which like reference numerals indicate similar elements and in which:

FIG. 1 illustrates an example operating environment in which various aspects of the disclosure may be implemented.

FIG. 2 illustrates an example erosion tracking system according to one or more aspects described herein.

FIG. 3 is an example illustration of aggregated insurance policies organized by subject matter or coverage type into subject-oriented insurance segments according to one or more aspects described herein.

FIG. 4 is an example method of tracking erosion according to one or more aspects described herein.

FIG. 5 illustrates another example of tracking erosion according to one or more aspects described herein.

### DETAILED DESCRIPTION

In the following description of various illustrative embodiments, reference is made to the accompanying drawings, which form a part hereof, and in which is shown, by way of illustration, various embodiments in which the claimed subject matter may be practiced. It is to be understood that other embodiments may be utilized, and that structural and functional modifications may be made, without departing from the scope of the present claimed subject matter.

Aspects of the arrangements described herein relate to tracking and understanding erosion of insurance limits. For instance, some large entities (e.g., large financial institutions and the like) may have multiple insurance policies provided by multiple providers in order to secure sufficient insurance coverage. Often, these insurance policies may be arranged by subject matter. Within these subject-oriented insurance segments are various layers of coverage (e.g., policies provided by various insurance providers, in various amounts, and the like). When aggregated, these policies within all of the subject-oriented insurance segments provide insurance coverage for the entity.

In some examples, a layer or policy segment of the subject-oriented insurance segment may span multiple subject-oriented insurance segments. For instance, in some insurance programs, insurance carriers may provide a limit of insurance for one type of coverage or subject matter that is shared with the limit of insurance provided for another type of coverage or subject matter. Thus, an annual aggregate for the policy may allow the insured (e.g., the entity implementing the system) to collect across both coverages or subject matter types from a single policy or a single limit. Accordingly, if a claim is applied to that particular policy segment, it will erode the available insurance in that policy segment in each subject-oriented insurance segment (e.g., coverage or subject matter type). This erosion that may span multiple subject-oriented insurance segments may be tracked to understand the remaining coverage available and to model various scenarios in order to conduct business. These and various other aspects of the arrangements will be described more fully below.

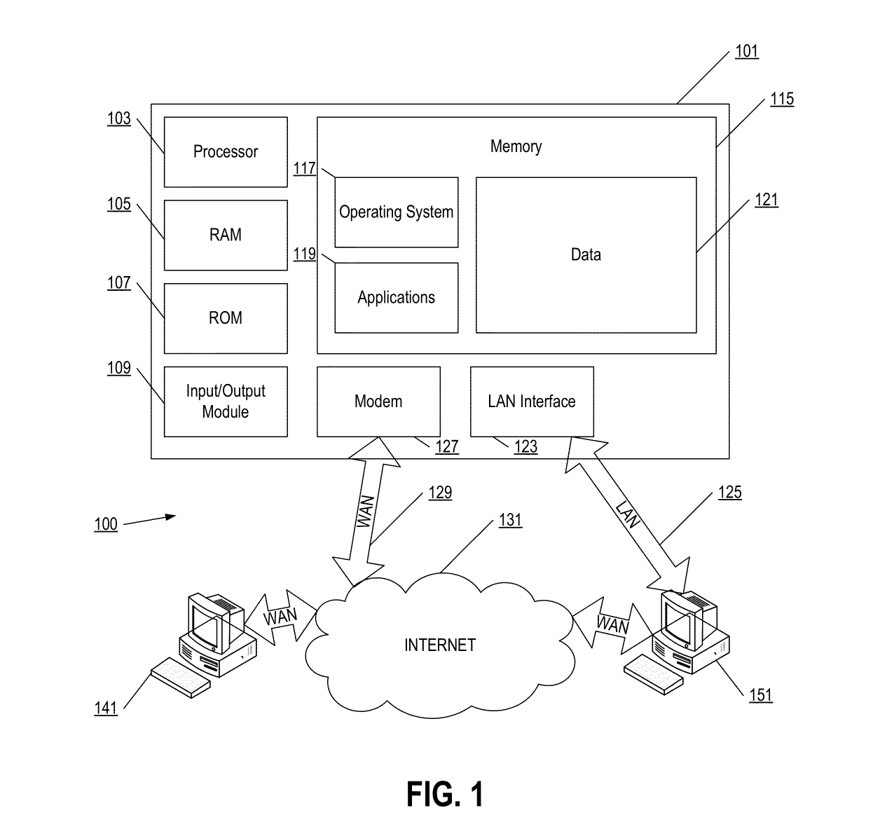

FIG. 1 illustrates an example block diagram of a generic computing device 101 (e.g., a computer server) in an example computing environment 100 that may be used in one or more illustrative embodiments of the disclosure. For example, the generic computing device 101 may correspond to a server in an system for tracking erosion of insurance limits, as described in examples below. The generic computing device 101 may have a processor 103 for controlling overall operation of the server and its associated components, including random access memory (RAM) 105, read-only memory (ROM) 107, input/output (I/O) module 109, and memory 115.

I/O module 109 may include a microphone, mobile device, mouse, keypad, touch screen, scanner, optical reader, and/or stylus (or other input device(s)) through which a user of generic computing device 101 may provide input, and may also include one or more of a speaker for providing audio output and a video display device for providing textual, audiovisual, and/or graphical output. Software may be stored within memory 115 and/or other storage to provide instructions to processor 103 for enabling generic computing device 101 to perform various functions. For example, memory 115 may store software used by the generic computing device 101, such as an operating system 117, application programs 119, and an associated database 121. Alternatively, some or all of the computer executable instructions for generic computing device 101 may be embodied in hardware or firmware (not shown).

The generic computing device 101 may operate in a networked environment supporting connections to one or more remote computers, such as terminals 141 and 151. The terminals 141 and 151 may be personal computers or servers that include many or all of the elements described above with respect to the generic computing device 101. The network connections depicted in FIG. 1 include a local area network (LAN) 125 and a wide area network (WAN) 129, but may also include other networks. When used in a LAN networking environment, the generic computing device 101 may be connected to the LAN 125 through a network interface or adapter 123. When used in a WAN networking environment, the generic computing device 101 may include a modem 127 or other network interface for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP, HTTPS, and the like is presumed.

Generic computing device 101 and/or terminals 141 or 151 may also be mobile terminals (e.g., mobile phones, smartphones, PDAs, notebooks, tablet computers, and the like) including various other components, such as a battery, speaker, and antennas (not shown).

The disclosure is operational with numerous other general purpose or special purpose computing system environments or configurations. Examples of well-known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

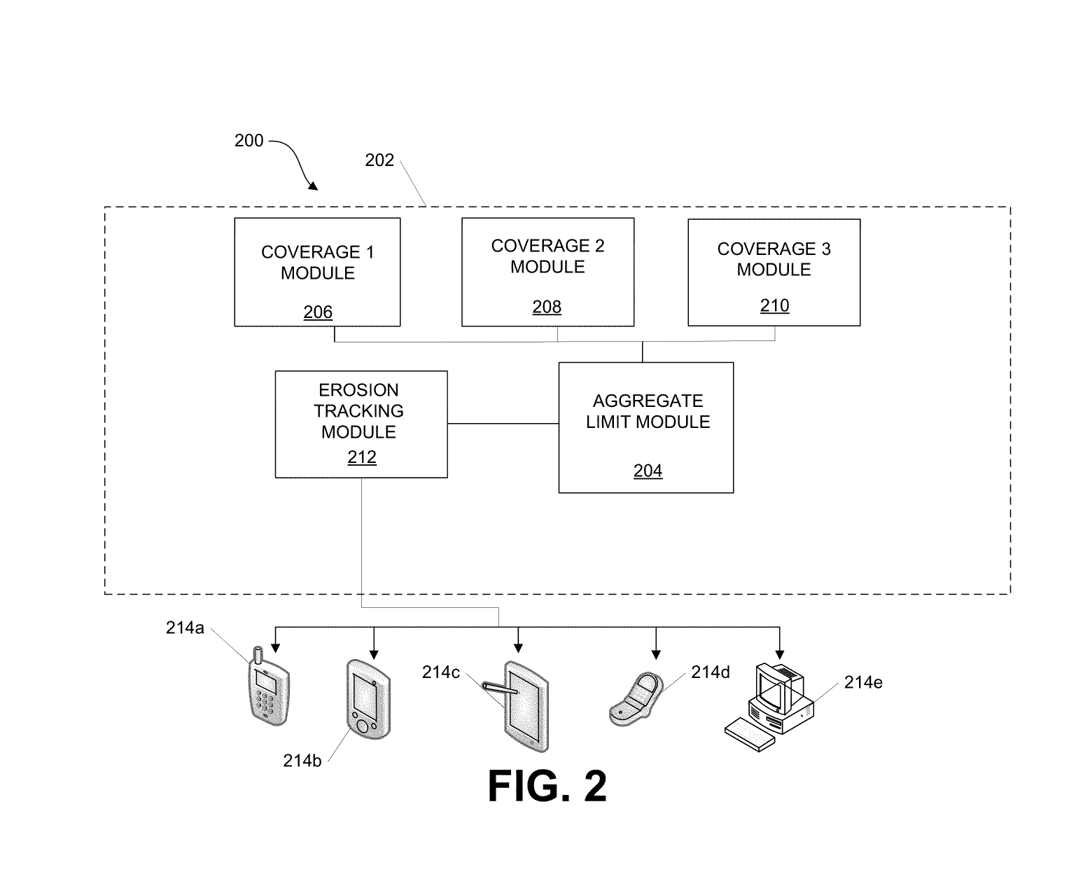

FIG. 2 illustrates one example erosion tracking system 200 according to one or more aspects described herein. In some examples, the erosion tracking system 200 may be part of, internal to or associated with an entity 202. The entity may be a corporation, university, government entity, and the like. In some examples, the entity 202 may be a financial institution, such as a bank. Although various aspects of the disclosure may be described in the context of a financial institution, nothing in the disclosure shall be construed as limiting the erosion tracking system to use within a financial institution. Rather, the system may be implemented by various other types of entities without departing from the invention.

The erosion tracking system 200 may include one or more coverage modules, such as modules 206, 208, 210. The coverage modules 206, 208, 210 may include information about one or more insurance policies, including amount of coverage, type of coverage, terms of a policy, deductibles, and the like. The coverage modules 206, 208, 210 may include information about various insurance policies from various providers, brokers, and the like.

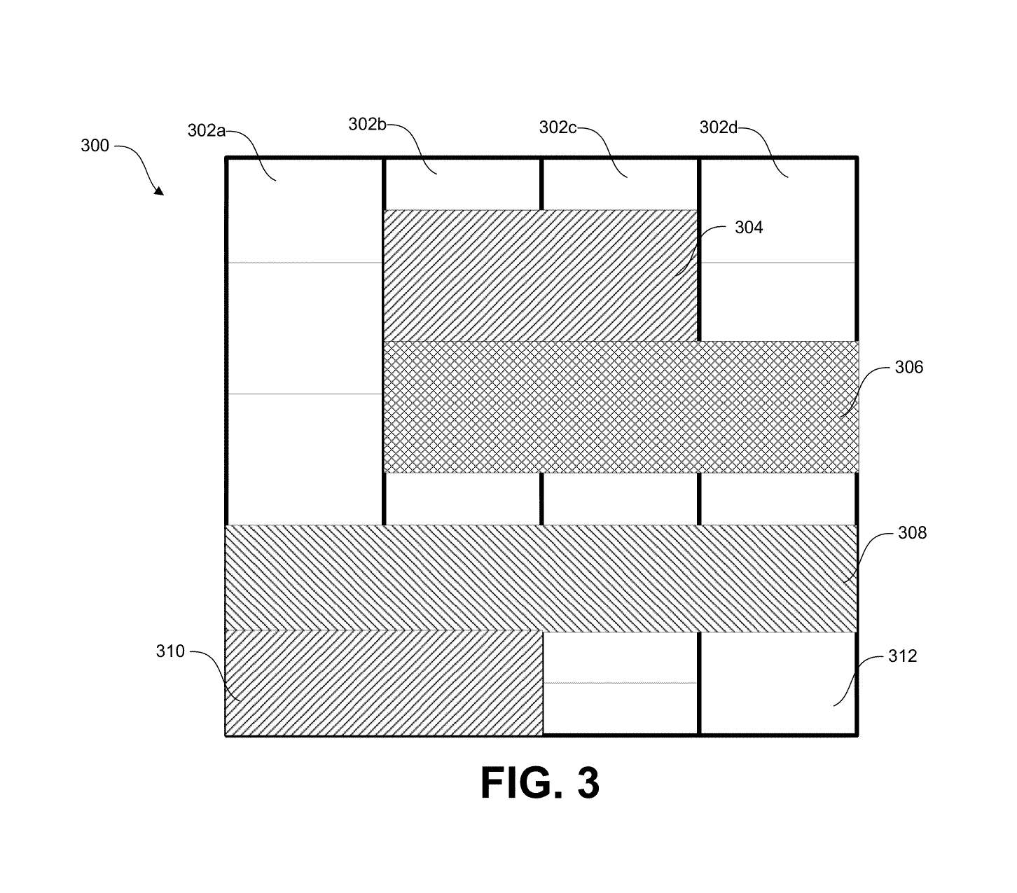

The erosion tracking system may further include an aggregate limit module 204. The aggregate limit module may aggregate the various insurance policies, such as those stored in coverage modules 206, 208, 210, to provide the overall insurance coverage, such as for the entity 202. In some examples, the aggregate limit module may sort the various policies into subject-oriented insurance segments. Each of these subject oriented insurance segments may include one or more layers or policy segments that may represent a particular insurance policy or coverage. FIG. 3 illustrates one example illustration of the aggregate insurance policies 300.

The aggregate 300 includes a plurality of subject-oriented insurance segments 302a-302d. These vertically oriented segments in the aggregate illustrate various insurance policies arranged according to subject. For instance, the policies may be sorted into comprehensive crime coverage, errors and omissions coverage, cyber liability coverage, as well as various other comprehensive, liability and other types of insurance policies. In some examples, the layers within each subject-oriented insurance segment may represent an insurance policy. For instance, layers or policy segments 302, 304, 306, 308, 310, and 312 may represent different insurance policies within the aggregate 300. As illustrated in FIG. 3, the policy segments 302-312 may be contained within a single subject-oriented insurance segment, such as policy segment 312 in subject-oriented insurance segment 302d. In other examples, the policy segment may span two or more subject-oriented insurance segments. For instance, policy segments 304 and 308 span two subject-oriented insurance segments 302b, 302c and 302a, 302b, respectively. Policy segment 306 spans three subject-oriented insurance segments 302b-302d. Policy segment 308 spans four subject-oriented insurance segments 302a-302d. More or fewer subject-oriented policy segments may be used without departing from the invention.

With further reference to FIG. 2, the erosion tracking system may further include an erosion tracking module 212. The erosion tracking module may receive insurance claim information and identify a subject-oriented insurance segment from which to deduct the claim payment. In some examples, the erosion tracking module 212 may identifying a policy segment from which to deduct the claim payment. The erosion tracking module 212 may then determine an amount of remaining insurance after deducting the claim payment amount. This remaining amount may be stored and may be used in determining a subject-oriented insurance segment and/or policy segment from which to pay out any additional claims.

For instance, as an insurance claim is made, it may be paid from one or more policy segments. However, if the policy segments span multiple subject-oriented insurance segments (as discussed with respect to FIG. 3), the reduction in the available amount of insurance for that policy segment and subject-oriented insurance segment may be tracked. For instance, if a claim is made and is paid out of policy segment 304 from subject-oriented insurance segment 302c, the reduction in the overall amount of insurance available for that policy is reduced by the amount of the claim. In conventional systems, this may only be recorded against the subject-oriented insurance segment from which the claim is paid (e.g., segment 302c). However, the system described herein may track the erosion of that amount from the overall policy segment 304 and thus would track the erosion for subject-oriented insurance segment 302b as well as segment 302c, thereby reducing the aggregate amount of insurance coverage available for, in some instances, the entity. Accordingly, a more accurate record of insurance coverage available may be maintained by the erosion tracking system. As additional claims are made, the process of determining from which policy segment and/or which subject-oriented insurance segment to pay the claim may be faster and more efficient because the accuracy of the amount of insurance available used to make the determination is improved. Further, more accurate forecasting and/or modeling of various scenarios may be provided by having a more accurate understanding of the remaining amount of insurance available.

In some examples, the amount of the claim may be received by the erosion tracking system and the erosion tracking system may automatically determine which subject-oriented insurance segment and/or which policy segment from which to pay the claim, based on the insurance available (e.g., including any erosion from previous claims), policy limits, and the like.

The above-described modules may include hardware and/or software and may include some or all of the components discussed with respect to FIG. 1.

The erosion tracking system 200 and the information stored therein may be accessible via one or more computing devices 214a-214e. The computing devices may include a smartphone 214a, a personal digital assistance 214b, a tablet computer 214c, a cell phone 214d, or a desktop or laptop computing device 214e, and the like. In some examples, the erosion tracking system 200, including various modules therein, may be accessible by employees of the entity 202 in order to track erosion of the available insurance. In still other examples, one or more aspects of the erosion tracking system 200 may be accessible by an individual or group outside of the entity 202, such as an insurance broker. The broker may input information into the system 200 about various policies (e.g., deductibles, limits, policy-types, and the like) and this information may be accessed via the system 200 by individuals associated with the entity 202. This may reduce or eliminate errors associated with receiving information from the broker and inputting the information into the system. Instead, the broker may directly input information into the system 200 thereby reducing the possibility of error.

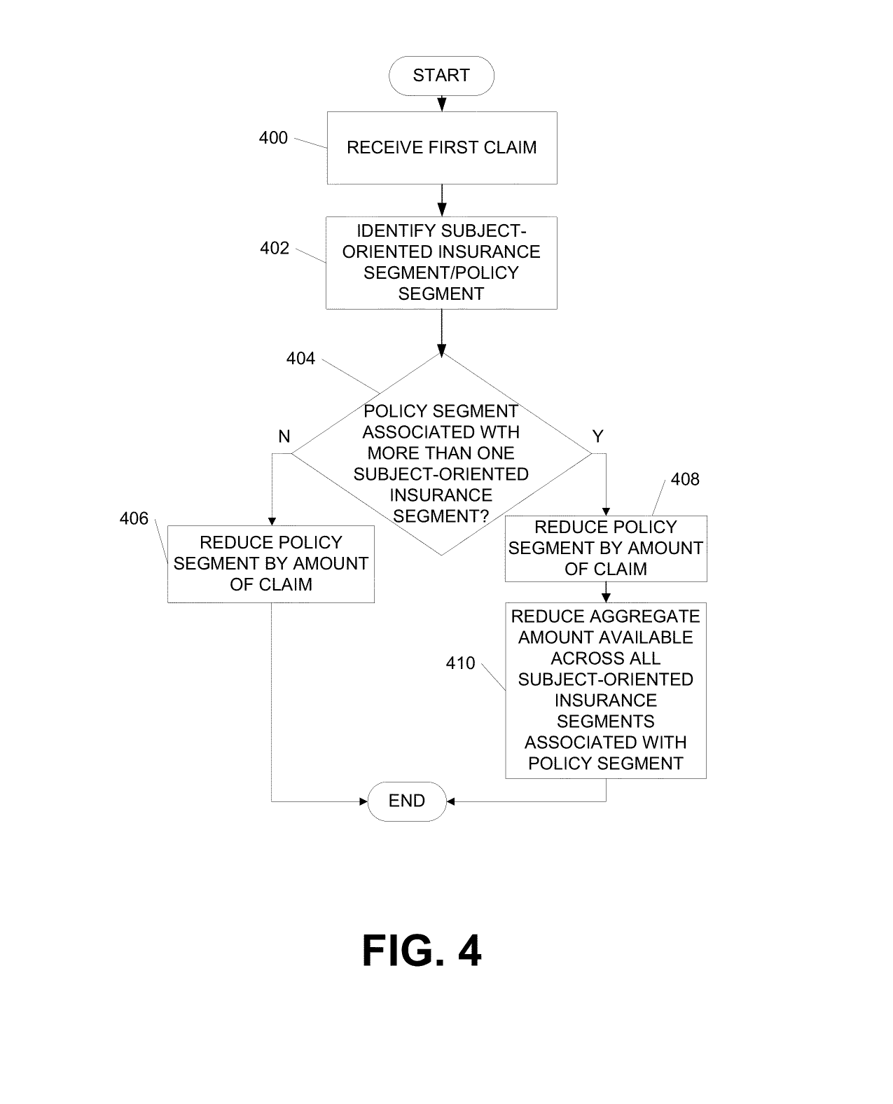

FIG. 4 illustrates one example method of tracking erosion according to one or more aspects described herein. In step 400, claim information is received. In some examples, the claim information may include type of claim, amount of claim, and the like. In step 402, the subject-oriented insurance segment and/or policy segment from which the claim amount will be paid are identified. In some examples, this identification may be performed automatically upon receipt of the claim information.

In step 404 a determination is made as to whether the identified policy segment is associated with more than one subject-oriented insurance segment. If not, the policy segment is reduced by the amount of the claim in step 406. Alternatively, if, in step 404, a determination is made that the identified policy segment is associated with more than one subject-oriented insurance segment, then the policy segment is reduced by the amount of the claim in step 408 and the aggregate amount available is also reduced in step 410. That is, the aggregate amount is reduced by reducing the amount available for the policy segment across all subject-oriented insurance segments associated with the identified policy segment. This may reduce or avoid instances in which the policy segment may span two or more subject-oriented insurance segments but only the subject-oriented insurance segment associated with the claim is reduced. Accordingly, the other subject-oriented insurance segments associated with the policy segment may not be reduced and may erroneously indicate that the full amount of insurance coverage is available. By reducing each subject-oriented insurance segment associated with the reduced policy segment, an accurate amount of insurance available will be provided.

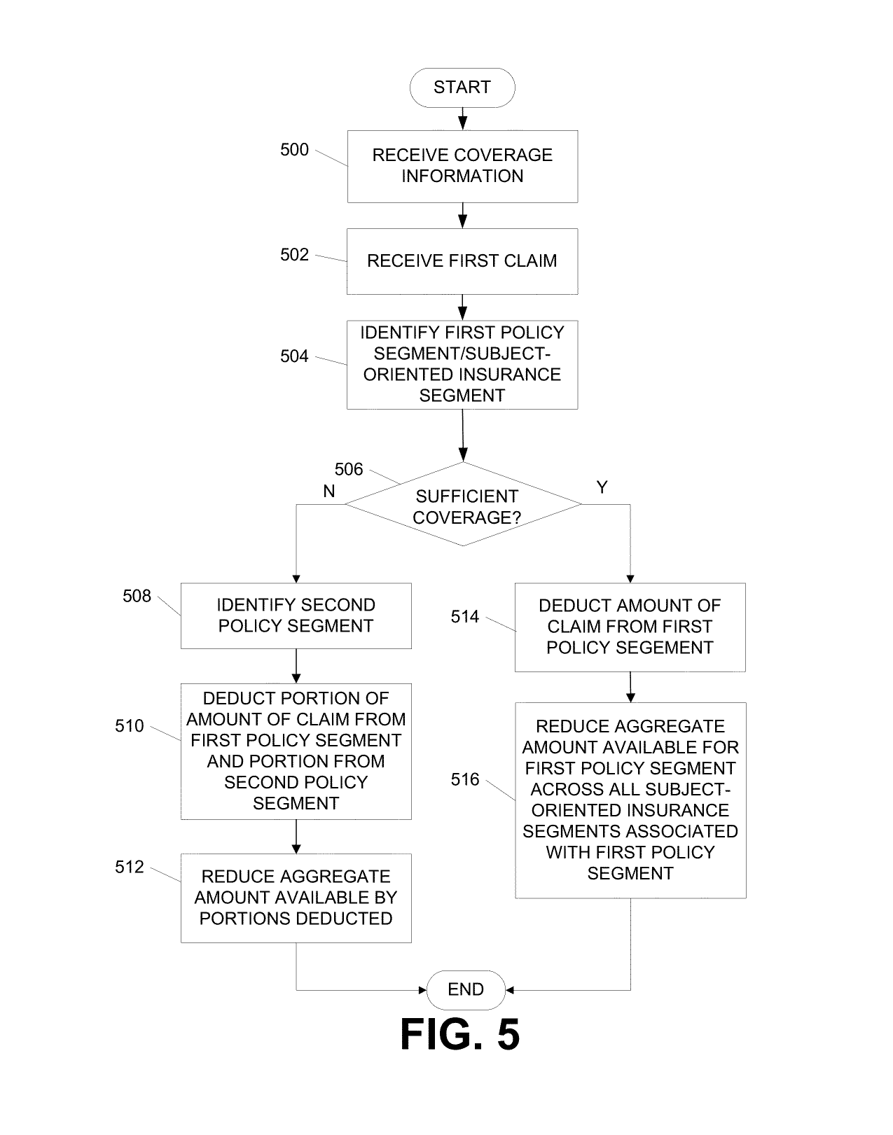

FIG. 5 illustrates another example method of tracking erosion according to one or more aspects described herein. In step 500, coverage information is received. As discussed above, the insurance coverage information may include one or more insurance policies from one or more insurance providers. In some examples, the information about the coverage may be provided by an insurance broker associated with the entity. The insurance broker may, in some arrangements, access the system (such as via one or more computing devices) and directly input the information about coverage, policies, and the like.

In step 502, claim information is received. Similar to the arrangement discussed above, the claim information may include an amount of the claim, type of claim, and the like. In step 504, a subject-oriented insurance segment and/or policy segment may be identified. The claim may be paid out of the identified policy segment within the identified subject-oriented insurance segment. In step 506, a determination is made as to whether there is sufficient coverage available in the identified policy segment. If there is not sufficient coverage available, a second policy segment may be identified in step 508. In some arrangements, the second policy segment may be within the same subject-oriented insurance segment. Stated differently, the first policy segment and second policy segment may be associated with at least one subject-oriented insurance segment common to both policy segments. In step 510, a portion of the claim may be paid from the first identified policy segment (such as the policy segment identified in step 504) and another portion of the claim may be paid from the second identified policy segment. Accordingly, in step 512, the aggregate amount of insurance available may be reduced for all subject-oriented insurance segments associated with the first policy segment and the second policy segment. That is, the amount of insurance available in each subject-oriented insurance segment associated with either the first policy segment or second policy segment may be reduced by the portion of the claim deducted from the respective policy segment.

Alternatively, if, in step 506 sufficient coverage is available, the claim may be paid from the first policy segment in step 514 and, in step 516, the amount of available insurance associated with each subject-oriented insurance segment associated with the first policy segment may be reduced by the amount of the claim.

As additional claims are received by the system, the process of identifying an appropriate subject-oriented insurance segment and policy segment from which to pay the subsequent claims may be similar to the arrangements described in FIGS. 4 and 5. However, the available amount of insurance will include any reductions associated with previously filed claims. Accordingly, the processing of the subsequent claims will be more efficient and less prone to errors because the amount of insurance available when processing the subsequent claims accurately reflects the reductions for prior claims.

One example of implementing the erosion tracking system by an entity having multiple insurance policies is provided below. The example provided below is merely one example scenario. Various other examples, claim amounts, and the like, may be used with the system without departing from the invention. Nothing in the specification should be viewed as limiting the system to only the below-described example.

Company A is a large entity requiring several millions of dollars of insurance of various types. Because no one insurance carrier is equipped to provide such extensive coverage, the entity has multiple insurance policies for various types of insurance from multiple insurance carriers. In some examples, these policies are provided by an insurance broker who provides the particulars of each policy to the erosion tracking system. The insurance policies may be grouped together by subject matter. However, in some examples, one policy may be written for two or more types of subject matter. That is, that policy may have a limit of $1 million that may be used for claims in two or more types of subject areas.

When an insurance claim is filed against Company A, the claim may be paid out of one of the several insurance policies or policy segments grouped within the type of insurance or subject matter associated with the claim. Accordingly, a policy segment from which the claim should be paid may be identified based on the type of insurance or subject-oriented insurance segment it is associated with. In this example, the claim may be for $100,000 and may be designated to be paid from Policy Segment A. If Policy Segment A is associated with just one subject-oriented insurance segment, Insurance Segment A, the claim may be processed and the amount of insurance available in Insurance Segment A would be $900,000 after the claim is paid.

Alternatively, Policy Segment A is associated with two subject-oriented insurance segments, Insurance Segment A and Insurance Segment B. If the claim deals with the subject matter of Insurance Segment A, the claim will be paid out and the available amount of insurance reflected in Policy Segment A for Insurance Segment A will be reduced by the amount of the claim. However, in conventional systems, Insurance Segment B may still reflect the full policy amount available in Policy Segment A (e.g., no deduction may be reflected for the claim paid out). Thus, if a claim is made against the subject matter of Insurance Segment B, it may appear as though the full policy amount is available but the actual amount available is the policy amount reduced by the amount paid out to the previous claim from Policy Segment A. This results in an inaccuracy regarding the amount of insurance coverage available which can lead to inefficiencies and errors. Accordingly, the system described herein would also deduct the amount of the claim from Policy Segment A associated with Insurance Segment B. Thus, the accurate amount remaining for that policy will be shown if another claim is rendered against either Insurance Segment A or Insurance Segment B.

As discussed above, the systems, methods, apparatuses and computer-readable media described herein provide improved efficiency and accuracy in processing insurance claims because it provides a more accurate indication of the amount of insurance available. Further, the erosion tracking systems, methods, computer-readable media, and apparatuses described herein permits modeling of losses. That is, various “what-if” scenarios may be considered in order to better forecast and plan for costs.

Additionally, the erosion tracking systems, methods, apparatuses and computer-readable media may reduce errors in inputting data by permitting an outside entity, such as an insurance broker, to access the system and input data regarding one or more policies (e.g., price, limits, fee, tax, and the like). This may reduce errors in inputting data that may occur in conventional systems in which a broker may transmit information to an operator of the entity who may input the data into a system. It may also permit early verification of an insurance purchase because the data input by the broker may be compared against a summary or other report provided to the entity (such as by an underwriter) to confirm that all parties have the correct terms, parameters, and the like.

The systems, methods, apparatuses and computer-readable media described herein may also aid in reducing or eliminating discrepancies in work processes because all parties involved in the purchase of an insurance policy (e.g., the entity and broker) may use the same system and thus will use the same work process to input data about a policy, process a claim, and the like.

Various aspects described herein may be embodied as a method, an apparatus, or as one or more computer-readable media storing computer-executable instructions. Accordingly, those aspects may take the form of an entirely hardware embodiment, an entirely software embodiment, or an embodiment combining software and hardware aspects. Any and/or all of the method steps described herein may be embodied in computer-executable instructions stored on a computer-readable medium, such as a non-transitory computer readable medium. Additionally or alternatively, any and/or all of the method steps described herein may be embodied in computer-readable instructions stored in the memory of an apparatus that includes one or more processors, such that the apparatus is caused to perform such method steps when the one or more processors execute the computer-readable instructions. In addition, various signals representing data or events as described herein may be transferred between a source and a destination in the form of light and/or electromagnetic waves traveling through signal-conducting media such as metal wires, optical fibers, and/or wireless transmission media (e.g., air and/or space).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure.

What is claimed is:

1. An apparatus, comprising:
at least one processor; and
memory storing computer-readable instructions that, when executed by the at least one processor, cause the apparatus to:
receive an insurance claim and associated insurance claim information, the associated claim information including at least an amount of the claim;
identify a policy segment associated with at least one subject-oriented insurance segment, the policy segment having insurance available to pay the amount of the received claim;
determine whether the identified policy segment is associated with more than one subject-oriented insurance segment; and
reduce the amount of insurance available for processing subsequent insurance claims from the policy segment for each subject-oriented insurance segment associated with the policy segment by the amount of the claim.

2. The apparatus of claim 1, further including a plurality of policy segments and the identified policy segment is one of the plurality of policy segments.

3. The apparatus of claim 2, wherein at least two policy segments of the plurality of policy segments are provided by different insurance providers.

4. The apparatus of claim 1, wherein the identified policy segment corresponds to an insurance policy.

5. The apparatus of claim 1, further including instructions that, when executed, cause the apparatus to:
receive policy segment information; and
aggregate the policy segment information into subject-oriented insurance segments.

6. The apparatus of claim 5, wherein the policy segment information is received from an insurance broker.

7. The apparatus of claim 6, wherein the policy segment information is received by the apparatus directly from the insurance broker.

8. A method, comprising:
receiving, by an erosion tracking system, an insurance claim and associated insurance claim information, the associated claim information including at least an amount of the claim;
identifying, by the erosion tracking system, a policy segment associated with at least one subject-oriented insurance segment, the policy segment having insurance available to pay the amount of the received claim;
determining, by the erosion tracking system, whether the identified policy segment is associated with more than one subject-oriented insurance segment; and
reducing, by the erosion tracking system, the amount of insurance available for processing subsequent insurance claims from the policy segment for each subject-oriented insurance segment associated with the policy segment by the amount of the claim.

9. The method of claim 8, further including a plurality of policy segments and the identified policy segment is one of the plurality of policy segments.

10. The method of claim 9, wherein at least two policy segments of the plurality of policy segments are provided by different insurance providers.

11. The method of claim 8, wherein the identified policy segment corresponds to an insurance policy.

12. The method of claim 8, further including:
receiving policy segment information; and
aggregating the policy segment information into subject-oriented insurance segments.

13. The method of claim 12, wherein the policy segment information is received from an insurance broker.

14. The method of claim 13, wherein the policy segment information is received by the apparatus directly from the insurance broker.

15. One or more non-transitory computer-readable media having computer-executable instructions stored thereon that, when executed, cause at least one computing device to:
receive an insurance claim and associated insurance claim information, the associated claim information including at least an amount of the claim;
identify a policy segment associated with at least one subject-oriented insurance segment, the policy segment having insurance available to pay the amount of the received claim;
determine whether the identified policy segment is associated with more than one subject-oriented insurance segment; and
reduce the amount of insurance available for processing subsequent insurance claims from the policy segment for each subject-oriented insurance segment associated with the policy segment by the amount of the claim.

16. The one or more non-transitory computer-readable media of claim 15, further including a plurality of policy segments and the identified policy segment is one of the plurality of policy segments.

17. The one or more non-transitory computer-readable media of claim 16, wherein at least two policy segments of the plurality of policy segments are provided by different insurance providers.

18. The one or more non-transitory computer-readable media of claim 15, further including instructions that, when executed, cause the apparatus to:
receive policy segment information; and
aggregate the policy segment information into subject-oriented insurance segments.

19. The one or more non-transitory computer-readable media of claim 18, wherein the policy segment information is received from an insurance broker.

20. The one or more non-transitory computer-readable media of claim 19, wherein the policy segment information is received by the apparatus directly from the insurance broker.
